(19) United States
(12) Patent Application Publication
(10) Pub. No.: US 2006/0026587 A1
(43) Pub. Date: Feb. 2, 2006

(54) Systems and methods for operating system migration

(76) Inventors: Luis Aguilar Lemarroy, Seattle, WA (US); Glenn Thomas, Seattle, WA (US)

Correspondence Address: PROCOPIO, CORY, HARGREAVES & SAVITCH LLP, 530 B STREET, SUITE 2100, SAN DIEGO, CA, 92101, US

(21) Appl. No.: 11/192,451

(22) Filed: Jul. 28, 2005

Related U.S. Application Data
(60) Provisional application No. 60/592,077, filed on Jul. 28, 2004.

(51) Int. Cl. G06F 9/44

(52) U.S. Cl. 717/170

(57) ABSTRACT

The present invention provides for systems and methods that recognize source and target devices and automatically identify, transfer, and convert user profiles, user settings, data, applications, and other information from the source device with its source operating system to the target device with its target operating system. The system surveys both the source device and the target device to ensure that each device has the appropriate resources and configuration to support the migration. Objects to be migrated are then identified, transferred to the target system and converted as necessary to create a similar environment on the target device as the previous environment on the source device. The post transfer integrity of the target device is then analyzed to ensure that the target system continues to work for its intended purpose and to further ensure that the migrated environment is also operational on the target device.

### RELATED APPLICATION

The present application claims priority to U.S. provisional patent application Ser. No. 60/592,077 filed on Jul. 28, 2004, which is incorporated herein by reference in its entirety.

### BACKGROUND

1. Field of the Invention

The present invention generally relates to the field of data migration and more particularly relates to migrating and converting data, settings, user profiles, applications, and other information from one operating system to another.

2. Related Art

When a computing device user wishes to change from one operating system to another or from one device to another, the user is faced with the difficult task of migrating all of the information that the user has accumulated on the device. In many cases, this information may be stored in memory and/or on storage peripherals in various locations that the user may not even be able to find. Moreover, the documentation needed to locate all of a user's information is scarce and highly technical. Furthermore, few vendors offer products to aid in migration tasks.

These significant problems are exacerbated by the large number of open and proprietary data formats that exist between applications, devices and operating systems. Often a complicated file conversion is required to move data from one system to another and few products and little documentation are available to assist the user in this arduous task.

Therefore, what is needed is a system and method that overcomes these significant problems found in the conventional systems as described above.

### SUMMARY

Accordingly, described herein are systems and methods that recognize source and target devices and automatically identify user profiles, user settings, data, applications, and other information objects on the source device with its source operating system and transfer those objects to the target device with its target operating system where they are converted as necessary for proper functioning on the target device.

In operation, the system may employ executable modules that run separately on the source and target devices. Alternatively, or in combination, the system may employ a server device that conducts the migration method over a network. Furthermore, the data transfer may be carried out on physical media such as a compact disc or it may be streamed or otherwise transferred over a network medium.

The system surveys both the source device and the target device to ensure that each device has the appropriate resources and configuration to support the migration. Objects to be migrated are then identified, transferred to the target system and converted as necessary to create a similar environment on the target device as the previous environment on the source device. The post transfer integrity of the target device is then analyzed to ensure that the target system continues to work for its intended purpose and to further ensure that the migrated environment is also operational on the target device.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a high level network diagram illustrating an example system for operating system migration according to an embodiment of the present invention;

FIG. 2 is a block diagram illustrating an example server for operating system migration according to an embodiment of the present invention;

FIG. 3 is a flow diagram illustrating an example process for preparing a source system for operating system migration according to an embodiment of the present invention;

FIG. 4 is a flow diagram illustrating an example process for preparing a target system for operating system migration according to an embodiment of the present invention;

FIG. 5 is a flow diagram illustrating an example process for migrating information objects from a source device to a target device according to an embodiment of the present invention;

FIG. 6 is a block diagram illustrating an exemplary wireless communication device that may be used in connection with the various embodiments described herein; and

FIG. 7 is a block diagram illustrating an exemplary computer system as may be used in connection with various embodiments described herein.

### DETAILED DESCRIPTION

Certain embodiments as disclosed herein provide for systems and methods that recognize source and target devices and automatically identify user profiles, user settings, data, applications, and other information objects on the source device with its source operating system and transfer those objects to the target device with its target operating system where they are converted as necessary for proper functioning on the target device. For example, one method as disclosed herein allows for a server computer to orchestrate migration of a user account from a source system to a target system where the two systems have disparate operating systems.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

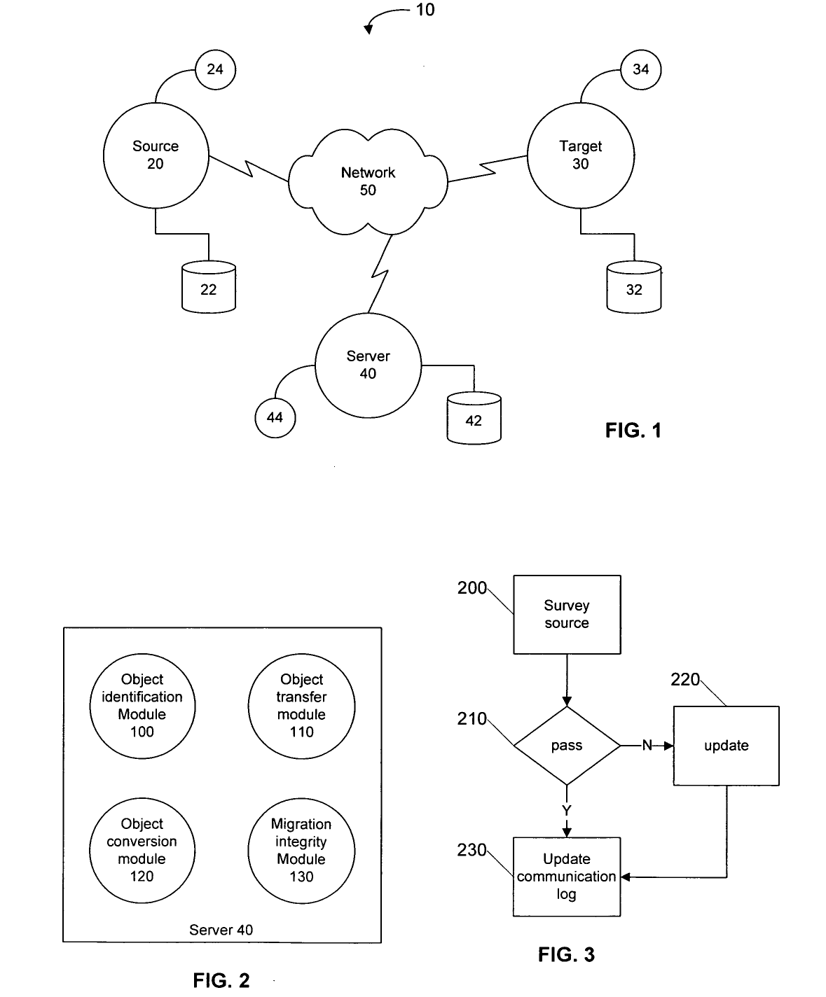

FIG. 1 is a high level network diagram illustrating an example system 10 for operating system migration according to an embodiment of the present invention. In the illustrated embodiment, the system 10 comprises a source device 20, a target device 30, and a server device 40 that are all communicatively coupled via a network 50. The source device 20 has a data storage area 22 and an input/output device 24. Similarly, target device 30 has a data storage area 32 and an input/output device 34 and the server device 40 has a data storage area 42 and an input/output device 44.

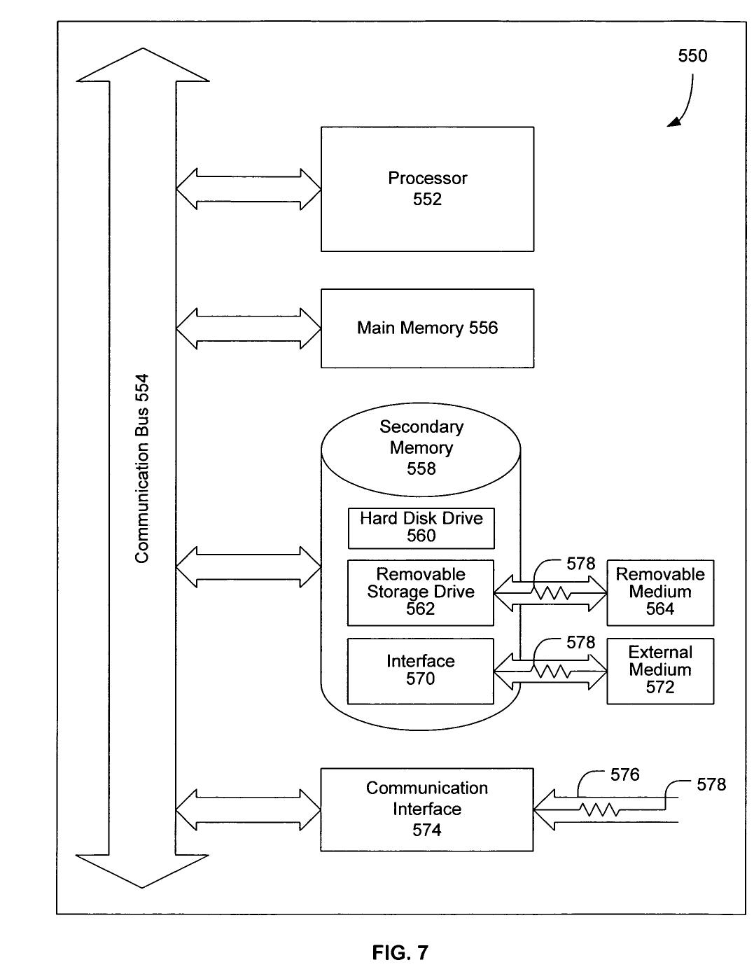

The devices 20, 30, and 40 can be of any of a variety of computing devices including a personal computer, server computer, workstation computer, laptop, palmtop, personal digital assistant (“PDA”), wireless communication device, cell phone, pager, or any other type of device capable of storing information objects and executing data migration programs. An example wireless communication device and general purpose computer device are later described with respect to FIGS. 6 and 7 respectively.

In a practical sense, each of the devices 20, 30, and 40 are capable of running disparate operating systems that control the various functions of each respective device. In particular, the source device 20 and the target device 30 are likely to run different operating systems, for example, source device 20 may run Microsoft Windows while target device 30 may run Mac O/S. Other combinations of operating systems such as Palm OS, AIX, BSD Unix, System V, Sun OS, Solaris, Windows CE, and the like can be running on devices 20 and 30, as will be understood by those having skill in the art.

The data storage areas 22, 32, and 42 can be of any of a variety of data storage devices included integral hard drives, external drives, flash, RAM, ROM, and removable media such as CDROM or DVD. The function of the data storage areas is to house data and programs that can be executed by a processor (not shown).

The input/output devices 24, 34, and 44 can be of any of a variety of devices including portable media devices, network communication interfaces, wireless communication interfaces including IEEE 802.11 interfaces, infra red communication interfaces, Bluetooth communication interfaces and the like. The input/output devices allow each device to gain access to portable media and to provide data on portable media for physical transfer to other devices.

The network 50 can be any of a variety of networks including a wired network, wireless network, public network, private network, packet switched network, circuit switched network, personal area network, local area network, wide area network, or any combination of networks such as the ubiquitous Internet.

FIG. 2 is a block diagram illustrating an example server 40 for operating system migration according to an embodiment of the present invention. In the illustrated embodiment, the server 40 comprises an object identification module 100, an object transfer module 110, an object conversion module 120, and a migration integrity module 130. As will be understood by those having skill in the art, these modules may alternatively be implemented on the source device 20, the target device 30, or some combination of the various devices shown in FIG. 1. The modules may also be resident on a portable media device such as a CD or DVD and then executed directly from such portable media device so that no modules are loaded into persistent memory on the source, target, or server devices.

In an alternative embodiment, certain modules may be implemented in software or hardware or some combination of the two, such as an application specific integrated circuit. Furthermore, various combinations of modules for the different functional tasks that are carried out by the modules are also possible. For example, in one embodiment there may be just a single module that carries out the functional tasks of all of the modules 100, 110, 120, and 130. In another embodiment there may be eight modules that carry out the functional tasks instead of four modules as illustrated in the embodiment shown in FIG. 2.

The object identification module 100 is configured to identify information objects for migration to a target machine. Some examples of information objects include users on the source device (including administrative system users with unique permissions and normal users with standard permissions). Information objects may also include user groups and all of the users associated with such a group. Information objects can also include various data that may be associated with a user account, for example, login scripts, shell scripts, configuration files for various applications such as command line interfaces (e.g., shells), mail programs, browser programs, graphical user interfaces, and the like.

In one embodiment, a group of information objects identified by the object identification module 100 may comprise an “environment” on the source device. For example, a username and password combination, home directory structure, preferences such as login program, configuration files, and the like may comprise an environment that could be described as a specific user environment. Other combinations of information objects may comprise other types of environments.

Advantageously, the object identification module 100 is configured to identify information objects and environments. In one embodiment, the object identification module 100 is configured to automatically identify such information objects and environments. In an alternative embodiment (or in combination) the object identification module 100 can be configured to work interactively with a user or administrator through a user interface that allows the user or administrator to selectively identify information objects and also to selective identify the information objects that comprise an environment.

The object transfer module 110 is configured to transfer identified information objects from the source device to the target device. In one embodiment, the object transfer module 110 may set up a stream of data from the source device to the target device. In an alternative embodiment, the object transfer module 110 may copy the information objects to an interim location such as a server or portable storage medium, and then make a second copy of the information objects to the target device. As will be understood by one having skill in the art, there are many ways to transfer data from the source device to the target device and the object transfer module 110 contemplates each such way to perform this function.

The object conversion module 120 is configured to convert information object from a first data format that is compatible with the operating system of the source device to a second data format that is compatible with the operating system of the target device. The object conversion module 120 is preferably capable of converting various formats of data, including text, ASCII, and binary formats. Similarly, the object conversion module 120 is preferably capable of recognizing interpreted data formats such as HTML, XML, Perl, shell scripts, and other platform independent information objects (assuming the target platform has an interpreter for the specific type of information object).

The migration integrity module 130 is configured to perform both pre-migration and post-migration analyses to determine if the migration can be carried out and to validate that the migration has been carried out successfully. For example, the migration integrity module 130 may survey the source device or target device prior to any migration to ensure that the device has the appropriate hardware and software resources to successfully migrate information objects. Furthermore, the migration integrity module 130 may make before and after comparisons on the target device to verify that the migration has been successfully and completely carried out and also to verify the absence of unintended results. In one embodiment, the migration integrity module 130 may make a pre-migration backup of data on the target device so that the target device may be restored to its pre-migration state if the migration effort was unsuccessful.

FIG. 3 is a flow diagram illustrating an example process for preparing a source system for operating system migration according to an embodiment of the present invention. Initially, in step 200 a survey on the source device is carried out. The survey preferably confirms that the source device has the needed hardware and software resources to carry out the migration process. The survey may also identify a set of information objects that are available for migration. This set can later be enhanced or re-defined by a user through a graphical user interface, command line interface, configuration file, or the like—for example, by stepping through a wizard application.

If the source device does not pass the survey, as determined in step 210, then in step 220 the source device can be upgraded. The upgrade of the source device can be automatic, such as downloading and installing an updated module for a particular application, or updating the firmware on an input/output device, downloading and installing an interpreter such as a web browser or it could involve more time consuming and labor intensive upgrades such as installing more memory. Once the upgrade is complete, or if none was required as determined in step 210, then in step 230 a communication log is updated or created if none previously existed.

One advantage to maintaining a communication log is so that subsequent operations of the migration utility are not required to duplicate certain steps that only need to be performed a single time or periodically.

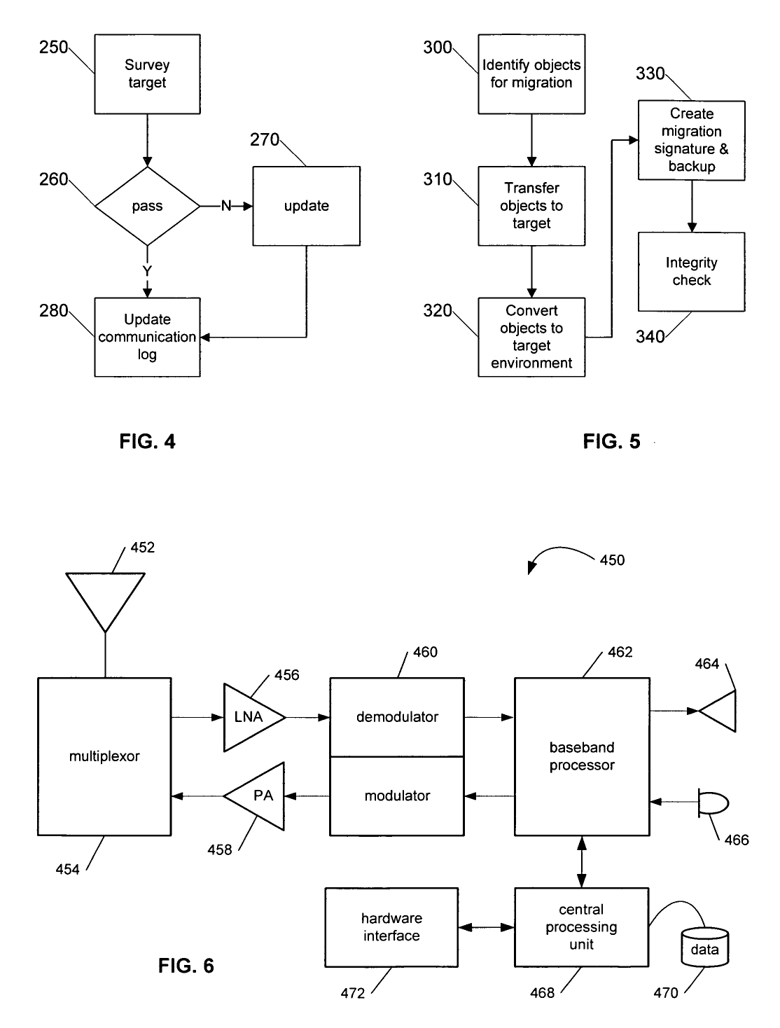

FIG. 4 is a flow diagram illustrating an example process for preparing a target system for operating system migration according to an embodiment of the present invention. The process in FIG. 4 is largely the same as the process previously described in FIG. 3 except that the process in FIG. 4 is carried out on the target device instead of the source device. Initially, in step 250 a survey on the target device is carried out. In a similar fashion, the survey preferably confirms that the target device has the needed hardware and software resources to carry out the migration process. This is where the similarities end, however. The survey on the target device may also make an inventory of the file structure and other information objects that are on the target device and then back up some or all of those items including the raw data in the file system. This pre-migration backup can advantageously be used later to restore the target device if the migration is for any reason unsuccessful.

If the target device does not pass the survey, as determined in step 260, then in step 270 the target device can be upgraded. The upgrade of the target device can be automatic, such as downloading and installing additional software, updating the firmware, or even reconfiguring or installing new hardware. Once the upgrade is complete, or if none was required as determined in step 260, then in step 280 a communication log on the target device is updated or created if none previously existed.

FIG. 5 is a flow diagram illustrating an example process for migrating information objects from a source device to a target device according to an embodiment of the present invention. Initially, in step 300 the objects for migration are identified. These objects can be automatically identified by the object identification module or selectively identified by a user, or some combination of the two. Once the objects are identified, they are transferred to the target device, as shown in step 310. The transfer may be direct as through a data stream or indirect as via a portable data storage medium. The transfer may also be indirect such as through a multi-stop file transfer process.

Next, on the target device, the transferred objects are converted, as necessary, to a format that is compatible with the operating system of the target device, as shown in step 320. A migration signature can be created next in step 330, where the migration signature comprises a list of pre-migration files on the target system and a list of post-migration files on the target system that can be compared to identify the changes that were made as part of the migration. The backup process identified in this step can be performed at any time prior to overwriting files on the target device as part of the migration so that in the case of an unsuccessful migration, the target system can be returned to its state immediately prior to the migration.

Finally, in order to determine whether the migration was successful or unsuccessful, an integrity check is performed in step 340. The integrity check may carry out a comparison of the post-migration signature to the pre-migration signature to analyze whether all of the information objects associated with the migrated environment are in fact present post-migration. Furthermore, the integrity check may also include the test execution of certain binary or interpreted programs to further validate the success of the migration. The integrity check may also provide a graphical user interface, command line interface, configuration file, or wizard interface to allow a user or administrator to also perform certain comparisons to validate the success of the migration.

FIG. 6 is a block diagram illustrating an exemplary wireless communication device 450 that may be used in connection with the various embodiments described herein. For example, the wireless communication device 450 may be used in conjunction with a source machine or target machine such as those previously described with respect to FIG. 1. However, other wireless communication devices and/or architectures may also be used, as will be clear to those skilled in the art.

In the illustrated embodiment, wireless communication device 450 comprises an antenna 452, a multiplexor 454, a low noise amplifier (“LNA”) 456, a power amplifier (“PA”) 458, a modulation circuit 460, a baseband processor 462, a speaker 464, a microphone 466, a central processing unit (“CPU”) 468, a data storage area 470, and a hardware interface 472. In the wireless communication device 450, radio frequency (“RF”) signals are transmitted and received by antenna 452. Multiplexor 454 acts as a switch, coupling antenna 452 between the transmit and receive signal paths. In the receive path, received RF signals are coupled from a multiplexor 454 to LNA 456. LNA 456 amplifies the received RF signal and couples the amplified signal to a demodulation portion of the modulation circuit 460.

Typically modulation circuit 460 will combine a demodulator and modulator in one integrated circuit (“IC”). The demodulator and modulator can also be separate components. The demodulator strips away the RF carrier signal leaving a base-band receive audio signal, which is sent from the demodulator output to the base-band processor 462.

If the base-band receive audio signal contains audio information, then base-band processor 462 decodes the signal and converts it to an analog signal. Then the signal is amplified and sent to the speaker 464. The base-band processor 462 also receives analog audio signals from the microphone 466. These analog audio signals are converted to digital signals and encoded by the base-band processor 462. The base-band processor 462 also codes the digital signals for transmission and generates a base-band transmit audio signal that is routed to the modulator portion of modulation circuit 460. The modulator mixes the base-band transmit audio signal with an RF carrier signal generating an RF transmit signal that is routed to the power amplifier 458. The power amplifier 458 amplifies the RF transmit signal and routes it to the multiplexor 454 where the signal is switched to the antenna port for transmission by antenna 452.

The baseband processor 462 is also communicatively coupled with the central processing unit 468. The central processing unit 468 has access to a data storage area 470. The central processing unit 468 is preferably configured to execute instructions (i.e., computer programs or software) that can be stored in the data storage area 470. Computer programs can also be received from the baseband processor 462 and stored in the data storage area 470 or executed upon receipt. Such computer programs, when executed, enable the wireless communication device 450 to perform the various functions of the present invention as previously described.

In this description, the term “computer readable medium” is used to refer to any media used to provide executable instructions (e.g., software and computer programs) to the wireless communication device 450 for execution by the central processing unit 468. Examples of these media include the data storage area 470, microphone 466 (via the baseband processor 462), antenna 452 (also via the baseband processor 462), and hardware interface 472. These computer readable mediums are means for providing executable code, programming instructions, and software to the wireless communication device 450. The executable code, programming instructions, and software, when executed by the central processing unit 468, preferably cause the central processing unit 468 to perform the inventive features and functions previously described herein.

The central processing unit is also preferably configured to receive notifications from the hardware interface 472 when new devices are detected by the hardware interface. Hardware interface 472 can be a combination electromechanical detector with controlling software that communicates with the CPU 468 and interacts with new devices.

FIG. 7 is a block diagram illustrating an exemplary computer system 550 that may be used in connection with the various embodiments described herein. For example, the computer system 550 may be used in conjunction with a source machine, a target machine, or a server machine such as those previously described with respect to FIG. 1. However, other computer systems and/or architectures may be used, as will be clear to those skilled in the art.

The computer system 550 preferably includes one or more processors, such as processor 552. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 552.

The processor 552 is preferably connected to a communication bus 554. The communication bus 554 may include a data channel for facilitating information transfer between storage and other peripheral components of the computer system 550. The communication bus 554 further may provide a set of signals used for communication with the processor 552, including a data bus, address bus, and control bus (not shown). The communication bus 554 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer system 550 preferably includes a main memory 556 and may also include a secondary memory 558. The main memory 556 provides storage of instructions and data for programs executing on the processor 552. The main memory 556 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 558 may optionally include a hard disk drive 560 and/or a removable storage drive 562, for example a floppy disk drive, a magnetic tape drive, a compact disc (“CD”) drive, a digital versatile disc (“DVD”) drive, etc. The removable storage drive 562 reads from and/or writes to a removable storage medium 564 in a well-known manner. Removable storage medium 564 may be, for example, a floppy disk, magnetic tape, CD, DVD, etc.

The removable storage medium 564 is preferably a computer readable medium having stored thereon computer executable code (i.e., software) and/or data. The computer software or data stored on the removable storage medium 564 is read into the computer system 550 as electrical communication signals 578.

In alternative embodiments, secondary memory 558 may include other similar means for allowing computer programs or other data or instructions to be loaded into the computer system 550. Such means may include, for example, an external storage medium 572 and an interface 570. Examples of external storage medium 572 may include an external hard disk drive or an external optical drive, or and external magneto-optical drive.

Other examples of secondary memory 558 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 572 and interfaces 570, which allow software and data to be transferred from the removable storage unit 572 to the computer system 550.

Computer system 550 may also include a communication interface 574. The communication interface 574 allows software and data to be transferred between computer system 550 and external devices (e.g. printers), networks, or information sources. For example, computer software or executable code may be transferred to computer system 550 from a network server via communication interface 574. Examples of communication interface 574 include a modem, a network interface card (“NIC”), a communications port, a PCMCIA slot and card, an infrared interface, and an IEEE 1394 fire-wire, just to name a few.

Communication interface 574 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 574 are generally in the form of electrical communication signals 578. These signals 578 are preferably provided to communication interface 574 via a communication channel 576. Communication channel 576 carries signals 578 and can be implemented using a variety of wired or wireless communication means including wire or cable, fiber optics, conventional phone line, cellular phone link, wireless data communication link, radio frequency (RF) link, or infrared link, just to name a few.

Computer executable code (i.e., computer programs or software) is stored in the main memory 556 and/or the secondary memory 558. Computer programs can also be received via communication interface 574 and stored in the main memory 556 and/or the secondary memory 558. Such computer programs, when executed, enable the computer system 550 to perform the various functions of the present invention as previously described.

In this description, the term “computer readable medium” is used to refer to any media used to provide computer executable code (e.g., software and computer programs) to the computer system 550. Examples of these media include main memory 556, secondary memory 558 (including hard disk drive 560, removable storage medium 564, and external storage medium 572), and any peripheral device communicatively coupled with communication interface 574 (including a network information server or other network device). These computer readable mediums are means for providing executable code, programming instructions, and software to the computer system 550.

In an embodiment that is implemented using software, the software may be stored on a computer readable medium and loaded into computer system 550 by way of removable storage drive 562, interface 570, or communication interface 574. In such an embodiment, the software is loaded into the computer system 550 in the form of electrical communication signals 578. The software, when executed by the processor 552, preferably causes the processor 552 to perform the inventive features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

1. A technical system for migrating information objects from a source device having a first operating system to a target device having a second operating system, the system comprising:
an object identification module configured to identify a plurality of information objects on a source device having a first operating system, the plurality of information objects defining a source environment;
an object transfer module configured to transfer the plurality identified information objects from the source device to the target device;
an objection conversion module configured to convert one or more of the transferred information objects to a format compatible with the second operating system; and
a migration integrity module configured to validate the transfer and conversion of the information objects comprising the source environment to a target environment on the target system.

2. The system of claim 1, wherein the object identification module is further configured to identify a source environment for a specific user on the source device.

3. The system of claim 1, wherein the object identification module is further configured to identify a source environment for a specific group on the source device.

4. The system of claim 1, wherein the object identification module is further configured to identify a source environment for a specific application on the source device.

5. The system of claim 1, wherein the object transfer module is further configured to transfer information objects over a data communication network.

6. The system of claim 5 wherein the data communication network is a wireless communication network.

7. The system of claim 1, wherein the object identification module executes on the source device.

8. The system of claim 7, wherein the object conversion module executes on the target device.

9. The system of claim 9, wherein the migration integrity module executes on the target device.

10. The system of claim 7, wherein the object transfer module executes on both the source device and the target device.

11. A computer implemented method for migrating information objects from a source device having a first operating system to a target device having a second operating system, the method comprising:
surveying a source device having a first operating system to identify sufficient resources on the source device to migrate information objects from the source device to a target device having a second operating system;
updating the source device to provide sufficient resources when such resources are not identified by said survey of the source device;
surveying the target device to identify sufficient resources on the target device to migrate information objects from the source device;
updating the target device to provide sufficient resources when such resources are not identified by said survey of the target device;
identifying a plurality of information objects on the source device, the plurality of information objects defining a source environment;
transferring the plurality identified information objects from the source device to the target device;
converting one or more of the transferred information objects to a format compatible with the second operating system; and
validating the transfer and conversion of the information objects comprising the source environment to a target environment on the target system.

12. The method of claim 11, wherein the source environment comprises information objects for a specific user on the source device.

13. The method of claim 11, wherein the source environment comprises information objects for a specific group on the source device.

14. The method of claim 11, wherein the source environment comprises information objects for a specific application on the source device.

15. The method of claim 11, wherein the transferring step transfers information objects over a data communication network.

16. The method of claim 15 wherein the data communication network is a wireless communication network.

17. A computer readable medium having stored thereon one or more sequences of instructions for causing one or more microprocessors to perform the steps for migrating information objects from a source device having a first operating system to a target device having a second operating system, the steps comprising:
surveying a source device having a first operating system to identify sufficient resources on the source device to migrate information objects from the source device to a target device having a second operating system;
updating the source device to provide sufficient resources when such resources are not identified by said survey of the source device;
surveying the target device to identify sufficient resources on the target device to migrate information objects from the source device;
updating the target device to provide sufficient resources when such resources are not identified by said survey of the target device;
identifying a plurality of information objects on the source device, the plurality of information objects defining a source environment;
transferring the plurality identified information objects from the source device to the target device;
converting one or more of the transferred information objects to a format compatible with the second operating system; and
validating the transfer and conversion of the information objects comprising the source environment to a target environment on the target system.

18. The computer readable medium of claim 17, wherein the source environment comprises information objects for a specific user on the source device.

19. The method of claim 17, wherein the source environment comprises information objects for a specific application on the source device.

20. The method of claim 17, wherein the transferring step transfers information objects over a data communication network.

21. The method of claim 20 wherein the data communication network is a wireless communication network.
